(19) United States
(12) Patent Application Publication
(10) Pub. No.: US 2004/0246700 A1
(43) Pub. Date: Dec. 9, 2004

(54) Fluid light apparatus and method

(76) Inventors: Stephen L. Palmer, Cameron Park, CA (US); William R. Palmer, Rescue, CA (US)

Correspondence Address: Michael A. Slavin, McHale & Slavin, P.A., 2855 PGA Boulevard, Palm Beach Gardens, FL, 33410, US

(21) Appl. No.: 10/457,797

(22) Filed: Jun. 6, 2003

(51) Int. Cl. F21K 2/00

(52) U.S. Cl. 362/34

(57) ABSTRACT

A photoluminescent fluid is caused to emit visible or non-visible electromagnetic energy by being irradiated with an excitation energy source, such as ultraviolet light. The fluid is circulated along or through a pathway to create certain special effects.

### FIELD OF THE INVENTION

This invention relates to the field of photoluminescence; particularly to the use of a photoluminescently excitable fluid media capable of absorbing energy for later release.

### BACKGROUND OF THE INVENTION

Chemiluminescence is the result of a chemical reaction caused by the mixing of an oxalate and an activator. The reactants are generally separately housed in a tubular device that can be flexed to rupture a membrane between the ingredients. No additional energy is needed for the reaction to produce visible light for a limited period of time. The glowing tube may be handled without protection.

Phosphorescence, or as we prefer, photoluminescence, refers to the phenomena which occurs when a material has the ability to store energy garnered via exposure to electromagnetic radiation and re-emit that stored energy at the same, or a different wavelength. It is typical for the emitted wavelength to be longer than the excitation wavelength. The exact chemistry and structure of the photoluminescent material ultimately defines the excitation and emission spectra. For example, zinc sulfide, as used in examples of the instantly disclosed invention, is excited via ultraviolet radiation and emits the absorbed energy as a longer wavelength green visible light.

Typically, emissions from an excited photoluminescent material exhibit a logarithmic discharge as a function of time. Emission starts out at a certain degree of brightness and slowly decays. This decay is expressed as a “half-life” time, with the half life being the time for the emission to reach one-half the initial output. Materials which act in this manner are defined as exhibiting a timed light degradation.

The use of a renewable excitation source allows the storage of energy and subsequent re-emissions to be carried out on a continuous basis to maintain the apparent brightness of the photoluminescent materials. Typically, the apparent brightness of photoluminescent materials diminishes quickly after charging is discontinued, although many photoluminescent materials are capable of emitting visible light for several hours after charging, especially if viewed via an individual's night vision in a dark environment.

### DESCRIPTION OF THE PRIOR ART

One specialized use of chemiluminescence is disclosed in U.S. Pat. No. 5,845,640 which teaches mixing the oxalate and activator in a reservoir and pumping the illuminating fluid through a catheter into a patient to photo-radiate a photosensitive drug located inside the patient's body.

An example of photoluminescence is set forth in U.S. Pat. No. 6,048,280 which teaches the use of ultraviolet light (UV) pulses to excite a phosphor included in or on a projectile to simulate a tracer round so that the flight of the projectile can be followed visually. The UV photo source is in the barrel of a gun and is activated immediately prior to launching the projectile so that the path of the projectile may be visually tracked.

U.S. Pat. No. 6,524,727 teaches electroluminescent devices having a high photoluminescent efficiency based on a transparent conductive substrate on which is a layer of electroluminescent material such as a rare earth metal, actinide or transition metal organic complex.

U.S. Pat. No. 6,499,145 teaches a glowing hat having a photoluminescent portion attached thereto which is charged by exposure to a light source, and subsequently worn during the period in which light is emitted.

U.S. Pat. No. 6,487,802 teaches a photoluminescent evacuation route kit containing a photoluminescent backing material which emits visible light subsequent to charging to aid in evacuation from a darkened area.

All of the above references require the photoluminescent material to be in a solid or non-fluid state. As such, the ability of having the light source traverse some type of arcuate path is not possible. Thus, there is a need in the art for a fluid or fluidizable photoluminescent material energized by use of a source of electromagnetic energy.

### SUMMARY OF THE PRESENT INVENTION

The present invention is directed toward providing a photoluminescent system comprising a fluid carrier vehicle constructed and arranged for transport of a photoluminescent material and a photoluminescent material entrained by said fluid carrier vehicle to form an energizable admixture. Upon exposure to an excitation source, an energized admixture results which has the ability to re-emit energy to provide visible or invisible electromagnetic energy. The invention is further directed toward a circulation system which transports said photoluminescent system along a pathway, and an excitation source constructed and arranged to irradiate said photoluminescent system, whereby an energized photoluminescent fluid admixture is produced for re-emission of visible or invisible electromagnetic energy.

A variety of fluid carrier vehicles are taught containing therein a photoluminescent material which, when charged with appropriate electromagnetic radiation, produces a flowing and glowing fluid capable of traversing any number of circuitous pathways, and providing a visual effect while doing so. This utility can be of interest in a variety of end uses; illustrative but non-limiting examples of which would be novelty items such as masks, costume elements of other shapes and sizes, fluid test devices, flow meters or valving wherein the presence of a photoluminous fluid would evidence, for example a flow vs. non-flow condition, medical devices such as visually augmented echocardiography, and the like.

The fluid may be aqueous or non-aqueous and the photoluminescent material may be one or more materials, useful either singly or in any admixture, which exhibit the ability to emit previously stored energy, in any suitable electromagnetic form, e.g. radiation in either the visible or invisible spectra, while entrained within a fluid carrier vehicle. While the photoluminous material is generally chosen to be relatively stable in the fluid vehicle, it is nevertheless within the purview of the instant invention to include materials of varying stability, capable of programmed degradation.

Furthermore it is contemplated to use various agents for viscosity control of the fluid vehicle; and to modify such parameters as particle size, emission spectra, density, particle color, magnetic character of particles, and the presence of various additional fluorescers or colorants to produce a variety of effects.

Accordingly, it is a primary objective of the instant invention to provide a fluid and photoluminous product for emission of electromagnetic energy.

It is another objective of this invention to provide a fluid and photoluminous product and apparatus for its use wherein the fluid becomes energized by its ability to store energy while flowing past a source of electromagnetic radiation, in particular an ultraviolet light producing LED or LED array, and subsequently re-emits said stored energy at the same or a different wavelength while it continues to flow along a pathway.

It is also an objective of this invention to teach the use of a photoluminescent material, photo irradiated with one portion of the spectrum, giving off illumination in the visible portion of the light spectrum.

Another objective of this invention is to teach the use of a photoluminescent fluid that visually illuminates and defines a pathway as it flows from one point to another.

A further objective of this invention is to teach the use of photoluminescent fluid to illuminate a flexible tube for insertion into sinuous cavities to provide light in areas inaccessible by direct rays.

Yet another objective of this invention is to teach the use of a closed integral system which includes a reservoir for the photoluminescent fluid, designed hollow pathways connecting the reservoir and desired configurations, and a source of photoillumination to excite the photoluminescent fluid.

A still further objective of the instant invention is to teach a fluid or fluidizable carrier material in combination with a photoluminescently active material wherein said photoluminescently active material is entrained by said carrier material.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 shows a diagrammatic view of an illustration of a form of the invention;

FIG. 2 shows a diagram of a flexible light tube;

FIG. 3 illustrates an advertising sign employing photoluminescent fluid; and

FIG. 4 illustrates a novelty fountain.

### DETAILED DESCRIPTION OF THE INVENTION

Definitions: In accordance with this invention a fluid is understood to mean a substance which undergoes continuous deformation when subjected to a shear stress.

In accordance with this invention a fluidizable material is understood to mean a solid material which may be converted into an expanded suspended mass which has many of the properties of a liquid, for example it has substantially a zero angle of repose, seeks its own level, and assumes the shape of the containing vessel.

In accordance with this invention a fluid carrier vehicle is understood to mean any fluid or fluidizable material capable of acting as a carrier for a material capable of exhibiting photoluminescent properties.

In accordance with this invention a photoluminescent material is understood to mean any material capable of storing energy, particularly but not limited to electromagnetic radiation, and re-emitting said energy at the same or at a different wavelength.

In accordance with this invention an excitation source is understood to mean a source of energy, such as electromagnetic radiation, which may be emitted continuously or discontinuously.

In accordance with this invention a photoluminous or photoluminescent fluid, or an energizable photoluminescent fluid admixture is understood to mean a fluid carrier vehicle in combination with a photoluminescent material.

Fluid lights in accordance with the instant invention will generally include a photoluminescent system which includes a fluid carrier vehicle, which is constructed and arranged for transport of the photoluminescent material; and a photoluminescent material entrained by said fluid carrier vehicle, and which forms an energizable admixture. Additionally, fluid lights will contain an excitation source for supplying energy to the photoluminescent system, thus resulting in an energized admixture which has the ability to re-emit the supplied energy so as to provide visible or invisible electromagnetic energy. Lastly, the fluid light may include a circulation system for transporting the photoluminescent system along a pathway. The pathway may be a restricted path, such as within one or more tubes, and is both repeatable and reproducible. Alternatively, the pathway may take the form of a variable pathway, for example a varied path which a fluid might take over or through some geometric shape, which is not well-defined and not designed to be exactly reproducible. The circulation system may be a closed-loop, or an open system, with or without a reservoir, so long as it meets the requirements of transport of the photoluminescent system along the chosen pathway.

The photoluminescent system, the circulation system and the excitation source may be varied, either singly or in any combination, to attain a variety of visual effects. Non-limiting examples of such variations would include transparent, translucent or variously colored areas along the flow pathway, variously colored photoluminescent materials, variously treated photoluminescent materials wherein the treatment has an effect on the quality or color of the light emitted therefrom, or which effects either the amount of energy or type of energy absorbed thereby, various or changing light sources, and various degrees of mixing or intermixing of the fluid or fluidized admixture.

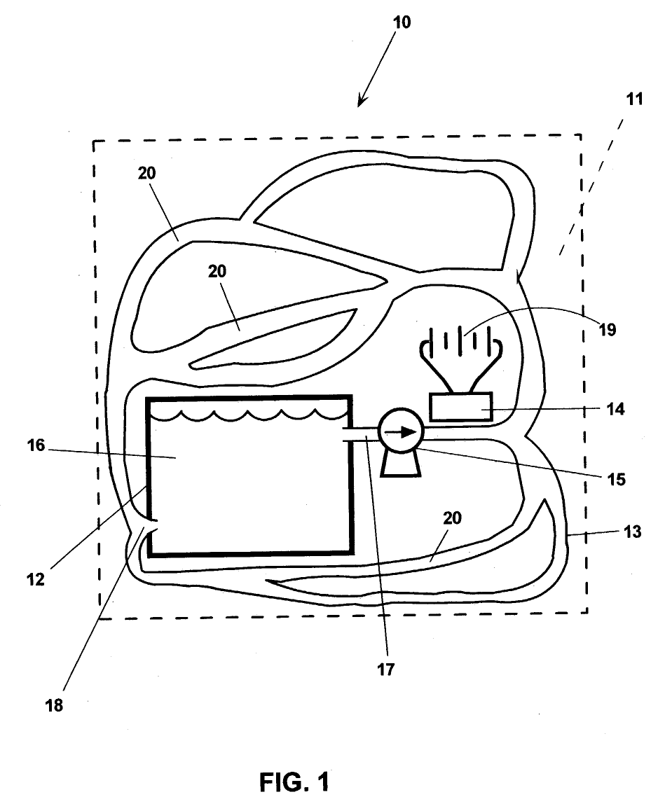

Now with reference to FIG. 1, a fluid light is shown having an integral system 10 with a formed enclosure 11. A reservoir 12 is shown within the enclosure 11 though it could be outside. Also shown within the enclosure is an excitation source 14 illustrated as being powered by a battery 19. Electrical power may alternatively be supplied from a standard electrical outlet through a converter.

The excitation source 14 is arranged in the enclosure to irradiate the energizable photoluminescent fluid admixture 16 as it exits the reservoir 12. The fluid admixture may include materials which alter the viscosity of the liquid or gaseous carrier vehicle but retain a flowing capability. The excitation source and the battery are illustrated as being constructed with access doors and connections in the enclosure so that each may be replaced as needed. The photoluminescent fluid is capable of providing visible illumination while traversing a pathway. In order to accomplish this a fluid carrier vehicle is provided which is constructed and arranged to transport a photoluminescent material along an arcuate path; and the photoluminescent material is entrained by said fluid carrier vehicle to form a dispersion or a fluidized admixture which constitutes an energizable photoluminescent fluid admixture. This dispersion may be homogeneous or non-homogeneous on a case-by-case basis. Exposure to an appropriate energy source results in an energized admixture which re-emits energy to provide visible/invisible illumination while traversing a pathway.

Of course, these components may also be on the exterior of the enclosure but arranged to perform the required function. The system also includes a pump 15 to move the photoluminescent fluid 16 now irradiated. In the closed system shown, the pump is fluidly coupled to the reservoir outlet 17 and used to produce fluid flow into the pathway 13. The shape of the pathway 13 is determined by the use of the system 10. As shown, the pathway 13 is divided into many interconnected channels 20 between the outlet 17 and the inlet 18 into the reservoir 12. Obviously, the system 10 may be arranged in such a manner that the return flow to the reservoir is by gravity.

The pump 15 may be a positive displacement piston, vane, or the walls of the reservoir may be flexible to provide variable volume, as required by the ultimate use. The pump may be manually powered, mechanically powered, electrically powered, or powered by any other suitable means. If electrically powered, the electrical source may be used for both the pump and the excitation source. The pump may be located outside the enclosure 11 but fluidly connected to the reservoir 12 and the pathway 13.

The excitation source 14 may provide photoenergy in the ultraviolet band (UV), the infrared band (IR) or the visible range of the light spectrum. While most photoluminescent materials can be charged using visible light, this is not always the most efficient mechanism. It is known that the use of visible light may, in fact, be detrimental to the desired process, in that the red, orange and IR, which are often present in “visible light” sources can cause photostimulation or photoquenching, which detrimentally effects the photoluminescent output. Thus, in an illustrative embodiment, the excitation source is an LED or array of LEDs or a lamp or lamps (singly or in any combination thereof) such as a halogen, a Xenon, or a fluorescent lamp, particularly (although not limited to) the UV range of the light spectrum. The lamp or the LED may be shielded from outside view to direct and concentrate the photo energy into the photoluminescent fluid and to prevent view of the source of photoluminescence in the fluid. The LED is available, for example from ETG Products. Furthermore, in the preferred embodiment, the operation of the excitation source and the pump are coordinated to provide either a timed sequence of activations of the excitation source or activation upon operation of the pump. When a plurality of excitation sources are employed, the sources may be excited simultaneously, sequentially or pulsed.

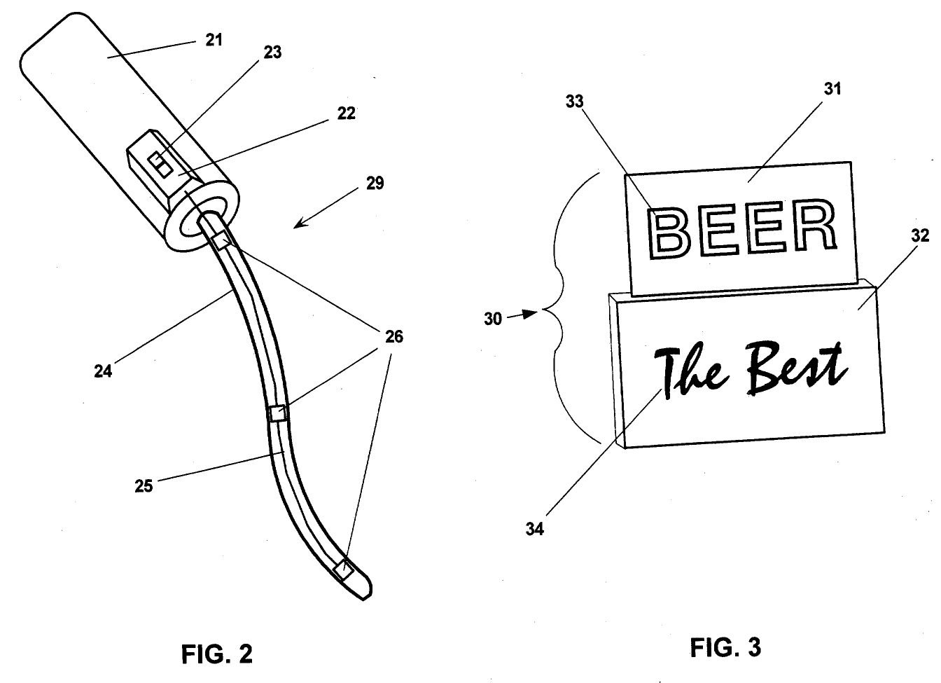

In FIG. 2 a flexible fluid light 29 is shown. The photoluminescent fluid is contained in the handle 21. The handle 21 may be rigid or have flexible walls which can be squeezed to act as a pump. The excitation source is powered by a battery in the compartment 22 and controlled by a switch 23. An electrical lead connects the battery with the LED 26 providing the excitation energy into the flexible transparent or translucent tubing 24. When the handle is squeezed the LED is energized and the photoluminescent fluid flows to illuminate the area surrounding the flexible tube. The pathway or tube 24 may have concentric channels for return flow or the channels may be side by side. There may be a plurality of LEDs 26 to provide more energy into the fluid as it traverses the channels. These LEDs may be energized simultaneously or sequentially along the length of the tube. This arrangement provides a brighter illumination at a greater distance from the reservoir.

FIG. 3 shows another embodiment of the photoluminescent fluid used in advertising or a sign 30. The sign has a printed backing 31 with a logo or other words 33 formed on the surface for permanent viewing. A transparent enclosure 32 is mounted over the backing 31 so that the margins are contiguous. The enclosure 32 contains all the elements of enclosure 11. The channels in the pathway of the enclosure 32 are in script 34 such as is common in neon type or gaseous discharge type signs. In a timed and repeated sequence, the script would be illuminated across the sign, as if written, resulting from the photoluminescent fluid being pumped through the channels from the outlet of the included reservoir to the inlet.

Photoluminenscent materials, in accordance with the instant invention, include those materials capable of storing energy when exposed to an excitation source in one band of the spectrum and re-emitting or shedding that energy at the same, or at a different wavelength or band. Typically, the emitted wavelength is longer than the excitation wavelength. The exact chemistry and structure of the photoluminescent material defines the excitation and emission spectra.

While any material is suitable for use in the instant invention, one of the preferred materials is a zinc sulfide and copper composition, designated hex-ZnS:Cu. In one example, the zinc sulfide is excited with UV radiation and emits a visible green illumination. The particular color of the visible illumination may be changed by using different radiation bands, the addition of dyes, phosphors or other devices.

The emissions from an excited photoluminescent material exhibit a logarithmic discharge as a function of time. While emissions start out bright and diminish over time. Many photoluminescent materials can be observed to emit illumination for several hours after excitation.

A photoluminescent material useful here is a water stable mixture obtained from United Mineral and Chemical Corp. and designated 6SSUY. Some zinc sulfide mixtures are not water stable and would require use of another carrier, such as a non aqueous polymer, oil, or the like. The flow characteristics of the photoluminescent fluid may also be controlled by adjusting the viscosity of the fluid carrier, as well as other parameters such as temperature, addition of emulsifiers, surfactants, or the like. Of course, use of multiple fluid carriers wherein the fluids have differing properties is encompassed within the fluid carriers of the instant invention. In addition to the zinc sulfides, there are aluminate based photoluminescent materials with trade names such as, LUMINOVA and LUMILUNA, available. The aluminates generally require more energy to excite but produce a visible illumination that is brighter and longer lasting than the zinc compositions. Additional photoluminescent materials include diblock copolymers, exemplified by, albeit not limited to, OPVn-PEGm having built-in functionalities. OPV or oligo(phenylenevinylene) is a photoluminescent polymer and PEG is poly(ethyleneglycol). These and other materials having similar functionalities may be formed into diblock polymers useful in the present invention.

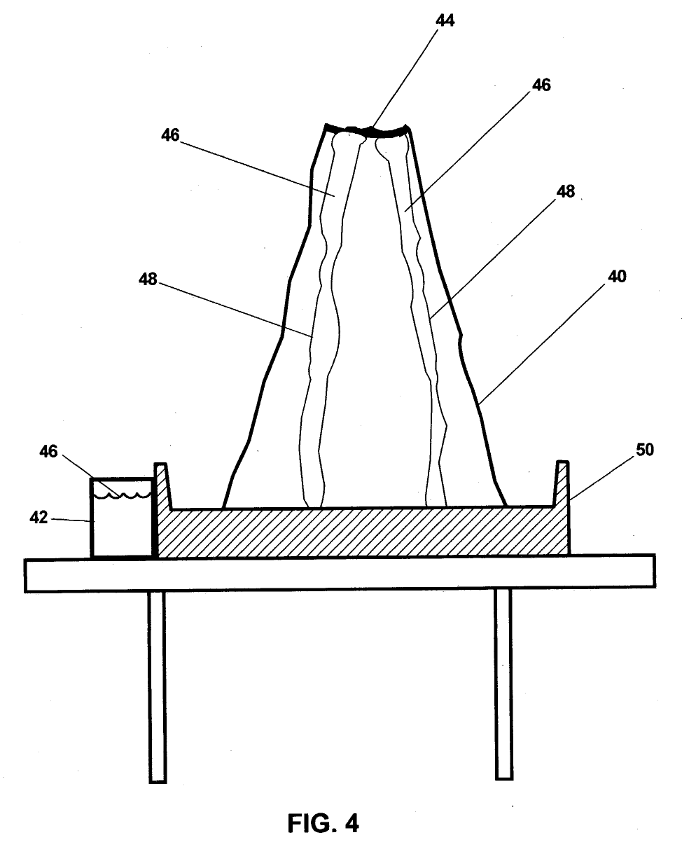

FIG. 4 shows another embodiment of the photoluminescent fluid wherein fluid is allowed to flow over the exterior of a structure 40. In this embodiment, a structure 40 employs a reservoir 42 (which may contain an integral pumping means (not shown)), for storing of flu-id which is pumped through an interior section of said structure 40 and expelled from at least one upper opening 44 wherein the fluid 46 travels along pathways 48 to the reservoir 42. The structural shape is merely exemplary, and might be the shape of a fountain, a volcano, a skull shape, and so forth. The structure 40 contains all the elements of enclosure 11. An optional collection means 50 is shown for use in directing the fluid back to the reservoir. The channels which form the fluid pathway will be illuminated during the flow of the energy-laden fluid. By employing a timed and repeated sequence of energization, the flow can appear to be waves of fluid, even though the fluid flow is constant, given that the emissions from an excited photoluminescent material can be used to exhibit a logarithmic discharge as a function of time.

All patents and publications mentioned in this specification are indicative of the levels of those skilled in the art to which the instant invention pertains. All patents and publications are herein incorporated by reference to the same extent as if each individual patent and publication was specifically and individually indicated to be incorporated by reference.

One skilled in the art will readily appreciate that the present invention is well adapted to carry out the objects and obtain the ends and advantages mentioned, as well as those inherent therein. Any methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed various modifications of the described modes for carrying out the invention which are obvious to those skilled in the art are intended to be within the scope of the following claims.

What is claimed is:

1. A photoluminescent system comprising:
a fluid carrier vehicle constructed and arranged for transport of a photoluminescent material; and
a photoluminescent material entrained by said fluid carrier vehicle to form an energizable admixture;
whereby exposure to an excitation source results in an energized admixture which re-emits energy to provide visible or invisible electromagnetic energy.

2. A fluid light comprising:
a photoluminescent system in accordance with claim 1;
a circulation system which transports said photoluminescent system along a pathway; and
an excitation source constructed and arranged to irradiate said photoluminescent system;
whereby an energized photoluminescent fluid admixture is produced for re-emission of visible or invisible electro-magnetic energy.

3. The fluid light of claim 2 wherein said excitation source is an LED or lamp.

4. The fluid light of claim 2 wherein said excitation source is a plurality of LEDs or lamps.

5. The fluid light of claim 4 wherein said plurality of LEDs or lamps are excited simultaneously.

6. The fluid light of claim-4 wherein said plurality of LEDs or lamps are excited separately.

7. The fluid light of claim 4 wherein said plurality of LEDs or lamps are pulsed.

8. The fluid light of claim 3 wherein said LED or lamp is pulsed.

9. The fluid light of claim 2 wherein said excitation source is a fluorescent energy source.

10. The fluid light of claim 2 wherein said excitation source is a UV energy source.

11. The fluid light of claim 3 wherein said LED is a UV energy source.

12. The fluid light of claim 2 wherein said excitation source is a halogen energy source.

13. The fluid light of claim 2 wherein said excitation source is a Xenon energy source.

14. The fluid light of claim 2 wherein said excitation source is a flash lamp energy source.

15. The fluid light of claim 2 wherein said circulation system includes a pump in fluid communication with said pathway;
whereby actuation of said pump causes said fluid to traverse said pathway.

16. The fluid light of claim 15 wherein said circulation system further comprises a reservoir.

17. The fluid light of claim 16 wherein said excitation source is mounted on said reservoir.

18. The fluid light of claim 2 wherein said pathway is at least partially transparent.

19. A fluid light of claim 2 wherein said pathway is at least partially translucent.

20. The fluid light of claim 2 wherein said fluid includes at least one color.

21. The fluid light of claim 2 wherein said fluid includes a plurality of colors.

22. The fluid light of claim 2 wherein said fluid includes a material capable of timed light degradation.

23. The fluid light of claim 2 wherein said visible or invisible energy re-emitted from said energized photoluminescent fluid admixture is re-emitted in one or more colors and/or wavelengths.
